(19) United States
(12) Patent Application Publication
(10) Pub. No.: US 2020/0090556 A1
(43) Pub. Date: Mar. 19, 2020

(54) Customizing Messages Using Character Patches

(71) Applicant: Fox LLC, Janesville, WI (US)

(72) Inventors: Justin Cole Fox, Janesville, WI (US); Kurt Sebastian Walter, Portland, OR (US)

(73) Assignee: Fox LLC, Janesville, WI (US)

(21) Appl. No.: 16/132,085

(22) Filed: Sep. 14, 2018

(51) Int. Cl. G09F 7/12; G09F 3/02; G09F 7/18; G09F 7/14; G09F 23/00; A41D 19/00; A41D 27/08

(52) U.S. Cl. CPC G09F 7/12; G09F 3/02; G09F 7/18; G09F 7/14; G09F 23/00; A41D 2300/32; A41D 27/08; A41D 19/0051; G09F 2003/0226; G09F 2003/0282; A41D 19/0024

(57) ABSTRACT

Customizing messages using character patches, by attaching a set of character patches to a substrate, using hook and loop fasteners. An assortment of character patches is selected and provided by a supplier. The user selects which ones, but not all, of the assortment to use, as a set, and arranges the set in a desired order to create a user-determined message. The selected character patches are mounted to one or more receptive patches on the substrate, in the arranged order, displaying the user-determined message. A sheet of the assortment of character patches, die-cut in a character patch layer, can be supplied mounted on a backing layer. As the user selects and removes character patches, the remaining character patches remain all together, mounted on the backing layer. The characters include at least one of numbers, letters, or other readily-recognized non-artistic characters, and can include characters which contain only artistic expressions.

### BACKGROUND OF THE INVENTION

This invention relates to messaging using character patches mounted to a substrate using hook and loop fastening, including personalizing and/or customizing an article of clothing or clothing accessory by attaching a set of character patches to the article of clothing or clothing accessory, using hook and loop fasteners.

It is common for a person to desire to put his/her personal thoughts, on a given subject, on display for public consumption. Various mechanisms are available for displaying thoughts, images, plans, desires, goals, dreams, emotions, views, names, and other information using an article of clothing or a clothing accessory as the substrate on which expression is displayed.

It is known, for example, to obtain a character patch, typically made of a cloth-like or plastic material, where the patch has first and second layers. The first layer is a base layer hearing a loop fastener array on a front side and a blank opposing rear side. The second layer is a character-display layer bearing a hook fastener array on a rear side and a character, to be displayed, on its opposing second side. The character-display layer of each character patch displays either a single well-recognized character or a well-recognized character set such as a word or phrase. In this patch system, the blank opposing side of the base layer is sewn, glued, or otherwise mounted to a substrate such as an article of clothing or a clothing accessory whereby the loop fastener array projects away from the substrate. The character-display layer is attached to the base layer by the hook fastener array on its first side engaging the loop fastener array on the exposed side of the base layer, thus engaging ones of the hooks on the character-display layer with the loop fastener array on the base layer.

By “article of clothing” is meant any article which covers a portion, or all, of a person's body, either as an outer garment or as an undergarment. Thus, a shirt, an undershirt, a blouse, a skirt, a pair of pants, a pair of underpants, a pair of exposed shorts, a pair of socks, shoes, a hat, a cap, a coat, a sweater, a scarf, and a robe are non-limiting examples of articles of clothing.

By a “clothing accessory” is meant an article which is generally associated with a person's apparel even though, as used, the article is more “carried” for extended periods of time to support a person's well being or other personal or business needs, as opposed to covering a portion of a person's body. Thus, as non-limiting examples of “clothing accessories”, there can be mentioned a purse, a backpack, a fanny pack, a lunch box, a water bottle, eyeglasses, a tote bag, a shopping bag, a briefcase, a folio, and the like. “Clothing accessory” does not include tools which, although they may be carried for extended periods of time, they are intended primarily for the purpose of doing work as applied to create change in a product, an assembly, or a process.

In order to display a message, the user must first obtain hook and loop patches of the characters needed for creating the message.

Then the user obtains a supply of the hook and loop patches of the characters needed for creating the message.

However, it is not uncommon that the user may change the message along the way whereby the character patches already obtained may not be adequate to create the latest message.

Or the user may use a first message for a while, and then desire to display a second different message, or to replace the first message with a second message.

Accordingly, it would be desirable to provide an assortment of character patches which represent readily-recalled, optionally commonly-known, characters in a given language or dialect, or vernacular, wherein a user can select some, but not all, of the character patches in the assortment, in order to create a first set of character patches which can be used to display a given character-based message.

It would also be desirable to provide such assortment of character patches which offers multiple ones of the more frequently used characters in the given language or dialect or vernacular.

It would also be desirable to provide such assortment of character patches removably mounted on a single backing sheet such that the backing sheet retains the character patches which have not yet been selected for use, thus to retain all of the unused character patches in a single given location, namely on the backing sheet.

It would further be desirable to provide the assortment of character patches mounted to such backing sheet using hook and loop fastening such that the character patches can be pulled/removed from the backing sheet by separating e.g. hook fasteners on the character patch from loop fasteners on the backing sheet, and to use the same hook fasteners on the character patch to mount the character patch to a receptive patch on an article of clothing or a clothing accessory.

These and other needs are alleviated, or at least attenuated, by the novel apparatus, products, and methods of the invention.

### SUMMARY OF THE INVENTION

This invention provides for messaging using character patches mounted to a receptive area on a substrate using hook and loop fastening. The contemplated messaging includes personalizing and/or customizing an article of clothing or clothing accessory, or other substrate, by attaching a set of character patches to the article of clothing or clothing accessory, or other substrate, using hook and loop fasteners.

It is common for a person to desire to put his/her personal thoughts, on a given subject, on display for public consumption. Various mechanisms are available for displaying thoughts, images, plans, desires, goals, dreams, emotions, views, names, and other information using an article of clothing or a clothing accessory as the substrate on which expression is displayed.

In the invention, an assortment of character patches, selected by a supplier, are made available to a user. The user selects which ones, but not all, of the available character patches are to be used, in a first set of at least first and second character patches, optionally a third character patch, and arranges the selected character patches in a desired order to create a user-determined message. The character patches are mounted to one or more receptive patches on the substrate in the arranged order thereby displaying the user-determined message.

A sheet of the assortment of multiple character patches, die-cut in a character patch layer, can be supplied mounted, collectively, on a backing layer. As character patches are selected and removed from the backing layer, the remaining character patches, namely the ones which have not yet been selected and removed, remain all together, in a single place mounted on the backing layer, available for future selection. The characters include at least one of numbers, letters, and other readily-recognized non-artistic characters, and can optionally include, but not exclusively, characters which contain only artistic expressions.

In a first family of embodiments, the invention comprehends, in combination, an article of clothing or a clothing accessory, the article of clothing or clothing accessory comprising one or more receptive portions thereof adapted to receive and to hold one or more character patches which bear either hook-type fasteners or loop-type fasteners; and an assortment of at least first, second, and third character patches bearing at least first and second different readily-recalled characters, including at least one of letters, numbers, or other readily-recalled characters, the character patches having fronts and rears, each character patch bearing a hook-type fastener area or a loop-type fastener area on the rear of the respective character patch, adapted to cooperate with the respective one or more receptive portions on the article of clothing or clothing accessory, wherein the character patch assortment is adapted to a user of such character patches (i) selecting a first set of at least first and second, but not all, of the character patches from the assortment of character patches, wherein a wide variety of user-determined messages can be created using the assortment of characters, and (ii) arranging the first set of character patches in such an order as to create a user-determined message, and attaching the first set of character patches to the article of clothing or clothing accessory at the respective one or more receptive portions in the arranged order by attaching the respective hooks or loops on the character patches to the cooperating one or more receptive portions, and thereby fastening the created message to the article of clothing or clothing accessory.

In some embodiments, the first set of character patches is not limited to artistic images only.

In some embodiments, the user determines the message to be displayed, and thereby determines which of the character patches, in the assortment of character patches, are selected for the first set of character patches.

In some embodiments, the particular characters in the assortment of character patches are selected by a supplier of such characters.

In some embodiments, the assortment of character patches is adapted to the user selecting, from the assortment of character patches, a second different set of character patches.

In some embodiments, the second set of character patches includes character patches from the first set of character patches, and the first set of character patches is replaced with the second set of character patches on the respective article of clothing or clothing accessory.

In some embodiments, the readily recalled characters are commonly-known characters.

In some embodiments, the assortment of character patches is embodied in a character patch sheet, the character patch sheet comprising a backing layer and an overlying character patch layer, the backing layer having a first length and a first width, a first front side and a first rear side, the front side bearing either hook-type fasteners or loop-type fasteners, the overlying character patch layer having a second front side and a second rear side, and a thickness between the second front side and the second rear side, a second length overlying at least a portion of the first length, and a second width overlying at least a portion of the first width, a plurality of the character patches being cut through the thickness of the overlying layer from the second front side to the second rear side so as to define, in the overlying character patch layer, an array of removable character patches, a given character patch having hook-type fasteners or loop-type fasteners, at the second rear side, attaching the respective character patch to the backing layer and cooperating with the respective hook-type or loop-type fasteners on the backing layer.

In some embodiments, a given character patch, in the character patch sheet, is at least partially encompassed by material of the overlying character patch layer which does not define a readily-recalled character.

In some embodiments, a user can pull a given character patch from the backing layer, and can use the hook-type fasteners or loop-type fasteners on the back of the respective character patch to attach the respective character patch to the article of clothing or clothing accessory.

In some embodiments, the assortment of character patches includes an entire alphabet of individual patches as well as multiples of letters, as individual character patches, which letters are more frequently used in a given language.

In some embodiments, the assortment of character patches includes at least one creatively artistic or graphic image.

In some embodiments, the assortment of character patches comprises at least ten different individual number characters.

In some embodiments, the assortment of character patches comprises at least one commonly-used character which is neither a number nor a letter.

In some embodiments, at least one of the character patches is adapted and configured to being attached, as an individual separate and distinct readily-recalled character, to a respective receptive portion of the article of clothing or clothing accessory.

In a second family of embodiments, the invention comprehends a character patch sheet comprising a backing layer and an overlying character patch layer, the backing layer having a first length and a first width, a first front side and a first rear side, the front side being adapted to receive and hold hook-type fasteners and/or loop-type fasteners, the overlying character patch layer having a second front side and a second rear side, and a thickness between the second front side and the second rear side, a second length overlying at least a portion of the first length, and a second width overlying at least a portion of the first width, an assortment of character patches, including at least one of number patches or letter patches, being cut through the thickness of the overlying character patch layer from the second front side to the second rear side, but not through the backing layer, so as to define, in the overlying character patch layer, an array of removable character patches, a given character patch having hook-type fasteners or loop-type fasteners, at the second rear side, removably attaching the respective character patch to the backing layer.

In some embodiments, a given removable character patch, including the hook-type fasteners or loop-type fasteners can be pulled from the character patch sheet and attached to a receptive article adapted to receive and hold respective hook-type fasteners or loop-type fasteners.

In some embodiments, the character patch sheet includes letter patches and number patches.

In some embodiments, the character patch sheet includes letter patches, number patches, and symbols or graphics which are neither letters nor numbers.

In some embodiments, the character patch sheet is devoid of patches which display only artistic content.

In a third family of embodiments, the invention comprehends a method of creating a personalized article of clothing or a clothing accessory, comprising providing an article of clothing or a clothing accessory wherein the article of clothing or clothing accessory comprises one or more receptive portions thereof adapted to receive and to hold one or more character patches which bear either hook-type fasteners or loop-type fasteners; providing an assortment of at least first, second, and third character patches bearing at least first and second different readily-recalled characters, including at least one of letters, numbers, or other readily-recalled characters, the character patches having fronts and rears, each character patch bearing a hook-type fastener area or a loop-type fastener area on the rear of the respective character patch adapted to cooperate with the respective one or more portions on such article of clothing or clothing accessory; selecting a first set of at least first and second, but not all, of the character patches in the assortment of character patches; and arranging the first set of character patches in such an order as to create a user-determined message, arid attaching the first set of character patches to the article of clothing or clothing accessory at the respective one or more receptive portions in the arranged order by attaching the respective hooks or loops on the character patches to the receptive portions on the article of clothing or clothing accessory.

In some embodiments, a supplier of the assortment of character patches selects the characters to be included in the assortment of character patches.

In some embodiments, the method includes the user selecting a second different set of character patches from the assortment of character patches, adapted to display a second different message, thereby creating first and second user-determined messages from the assortment of character patches.

In some embodiments, the second set of character patches includes character patches from the first set of character patches, the user replacing the first set of character patches with the second set of character patches on the respective article of clothing or clothing accessory in such an order that the second different message is displayed.

In some embodiments, the assortment of character patches is embodied in a character patch sheet, the character patch sheet comprising a backing layer and an overlying character patch layer, the backing layer having a first length and a first width, a first front side and a first rear side, the front side being adapted to receive and hold hook-type fasteners and/or loop-type fasteners, the overlying character patch layer having a second front side and a second rear side, and a thickness between the second front side and the second rear side, a second length overlying at least a portion of the first length, and a second width overlying at least a portion of the first width, the character patches being cut through the thickness of the overlying layer from the second front side to the second rear side so as to define, in the overlying character patch layer, the assortment of removable character patches in the character patch sheet, a given removable character patch having hook-type fasteners or loop-type fasteners, at the second rear side, attaching the respective character patch to the backing layer, the method comprising the user selecting a message to be created using at least first and second ones, but not all, of the character patches from the assortment of character patches, and removing a plurality, but less than all, of the removable character patches from the backing layer according to the user-selected message, and using hook-type fasteners or loop-type fasteners on the backs of the respective removed character patches to attach the respective character patches to the one or more receptive portions of the article of clothing or clothing accessory.

In some embodiments, the method includes the user selecting a second different set of character patches from the assortment of character patches to be used to create a second different user-determined message, the user arranging the second set of character patches in an order so as to display the second different message, and attaching the second different set of character patches to a such article of clothing or clothing accessory in the arranged order.

In some embodiments, the second set of character patches includes character patches from the first set of character patches.

In a fourth family of embodiments, the invention comprehends a method of making a character patch sheet having a backing layer and an overlying layer of removably attached character patches, the method comprising providing a backing layer having a first length and a first width, a first front side and a first rear side, the front side and being adapted to receive and hold hook-type fasteners and/or loop-type fasteners; attaching, to the backing layer, an overlying character patch layer having a second front side and a second rear side, and a thickness between the second front side and the second rear side, the overlying character patch layer having a second length and a second width defining an outer perimeter of the overlying character patch layer, the second length of the overlying layer overlying at least a portion of the first length of the backing layer, and the second width of the overlying layer overlying at least a portion of the first width of the backing layer; cutting an assortment of character patches through the thickness of the overlying layer from the second front side to the second rear side, but not through the backing layer, and inward of the perimeter of the overlying character patch layer, so as to define, within the outer perimeter of the overlying character patch layer, an array of removable character patches, a given character patch having hook-type fasteners or loop-type fasteners, at the second rear side, attaching the respective character patch to the backing layer.

In some embodiments, a given removable character patch, including the hook-type fasteners or loop-type fasteners can be pulled from the character patch sheet and attached to a receptive article adapted to receive and hold respective hook-type fasteners or loop-type fasteners.

In some embodiments, the method includes cutting the assortment of character patches to include letter patches and number patches.

In some embodiments, the method includes cutting the assortment of character patches to include letter patches, number patches, and patches defining symbols which are neither letters nor numbers.

In some embodiments, the method includes cutting the assortment of character patches such that the assortment of character patches is devoid of being only patches which display only artistic content.

These and other features and advantages of this invention are described in, or are apparent from, the following detailed description of various exemplary embodiments of the apparatus and methods, and uses, according to this invention.

### BRIEF DESCRIPTION OF THE DRAWINGS

A more complete understanding of the present invention and the attendant features and advantages thereof may be had by reference to the following detailed description when considered in combination with the accompanying drawings wherein various figures depict certain embodiments of the various elements, and methods of use, of character patches of the invention.

FIG. 1 shows a pictorial view of the back side of a first glove, as an article of clothing, wherein each of the four longer fingers bears a loop fastener patch between the first knuckle and the base of the hand, and a first set of character patches, conveying a first message, is mounted on the loop fastener patches on the respective fingers.

FIG. 2 is a pictorial view of the glove of FIG. 1 from a different perspective.

FIG. 3 is a pictorial view of a second different glove, as an article of clothing, illustrating a second set of character patches on the back side of the glove, conveying a second message, mounted on the loop fastener patches on respective fingers.

FIG. 4 is a pictorial view showing the front side of the glove of FIG. 3.

FIG. 5 is a pictorial view of a pair of gloves, as articles of clothing, illustrating a third set of character patches on the back sides of the four longer fingers.

FIG. 6 is a front elevation view of a character patch sheet of the invention, bearing an assortment of character patches.

FIG. 6A is a side elevation view, taken at 6A-6A in FIG. 6, illustrating both the backing layer and the overlying character patch layer, as well as the hook and loop fasteners projecting from the backing layer and the overlying character patch layer.

FIG. 7 is a pictorial view showing the back side of a portion of a glove, a portion of a character patch sheet with patches missing, and a selected set of characters between the patch sheet and the glove, wherein a first one of the characters is partially attached to a loop fastener patch on one of the fingers of the glove.

FIG. 8 is a pictorial view of a portion of a backpack wherein a character set has been attached, using hook fasteners, to a loop fastener patch on the rear of the backpack.

The invention is not limited in its application to the details of construction, or to the arrangement of the components set forth in the following description or illustrated in the drawings. The invention is capable of other embodiments or of being practiced or carried out in various other ways. Also, it is to be understood that the terminology and phraseology employed herein is for purpose of description and illustration and should not be regarded as limiting. Like reference numerals are used to indicate like components.

### DETAILED DESCRIPTION OF THE ILLUSTRATED EMBODIMENTS

This invention relates to assortments of patches bearing letters, numbers, and other readily-recalled characters, and may include artistic and/or graphic symbols, all as character patches applied to and/or removed from a target substrate, such as an article of clothing or clothing accessories, using hook and loop fastening, where the user selects a desired character set, but less than all characters, from an assortment of character patches supplied by a supplier, optionally on one or more backing sheets using a hook and loop fastener attachment system, both on the backing sheet and on the target substrate.

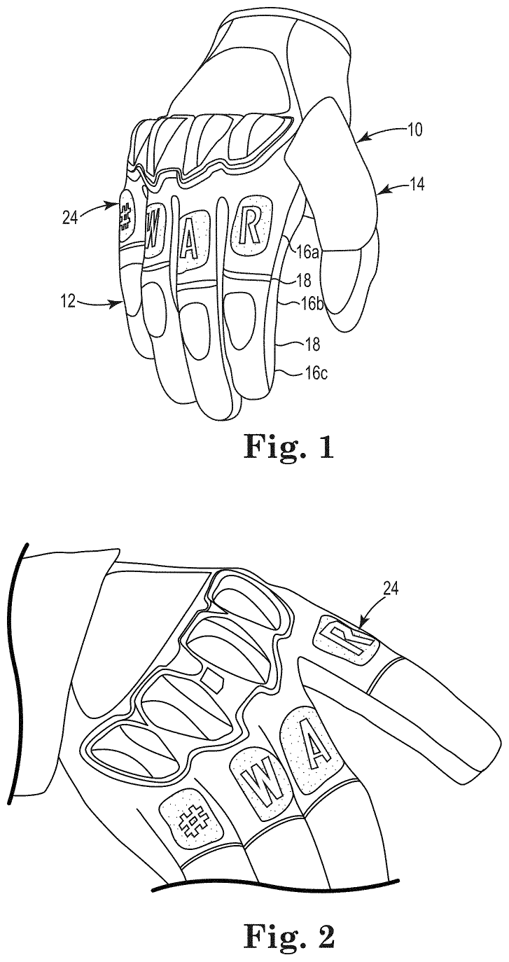

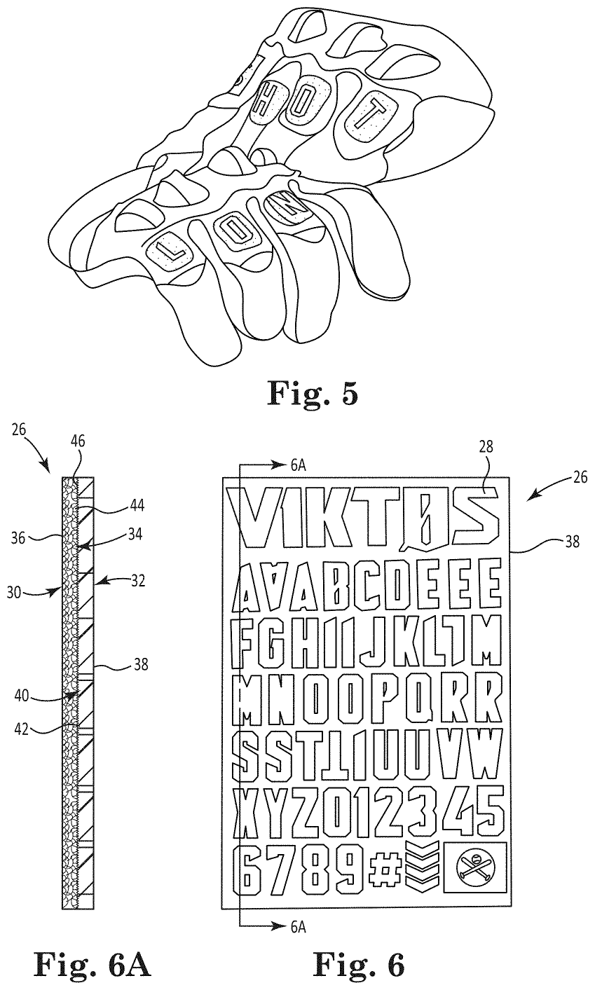

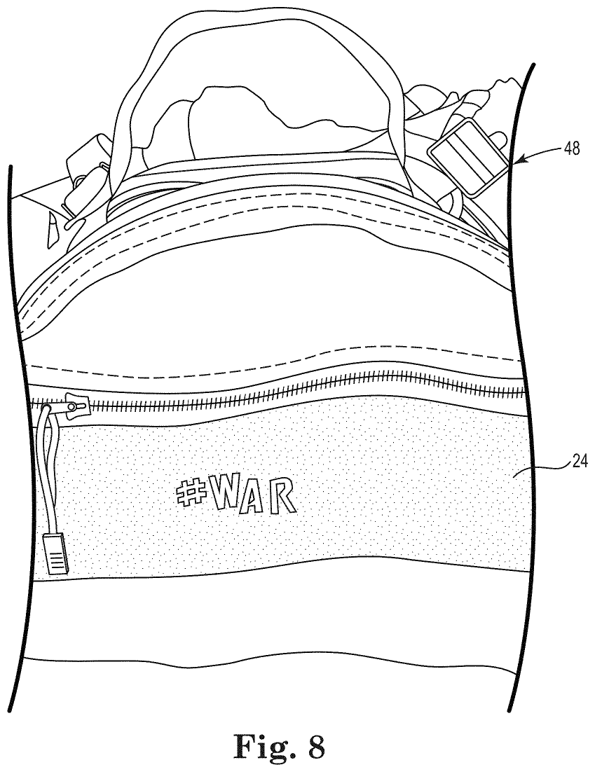

FIGS. 1-5 illustrate embodiments of the use of sets of character patches, such as letters, on glove substrates. FIG. 8 illustrates a similar use of a set of character patches on a backpack.

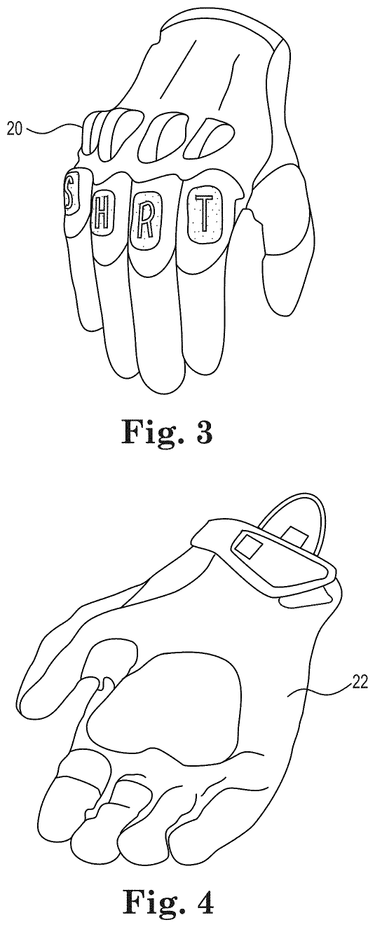

As illustrated in FIGS. 1-5, a glove 10 has four relatively longer fingers 12 and a relatively shorter thumb 14. Each finger and each thumb has a first finger/thumb segment 16a closest to the main body of the glove, a second finger/thumb segment 16b next to the first segment, and a third finger/thumb segment 16c furthest from the body of the glove, the second segment being between the first segment and the third segment. The respective finger/thumb segments on a given finger/thumb are separated from each other by first and second finger/thumb joints 18 and a third joint between the first segment 16a and the body of the glove. As illustrated in FIGS. 3-4, a given glove has a back side 20 and a front side 22, and the respective fingers and thumb have corresponding back sides and front sides.

In the invention, on the back side of the glove, at one of the finger segments, typically on each finger, optionally on the thumb, a receptive patch 24 of loop-type fastener material is mounted to the backs of the respective finger or thumb, namely between adjacent ones of the joints 18. If desired, receptive patches 24 can extend across joints 18 and/or can extend the full length of the respective finger or thumb.

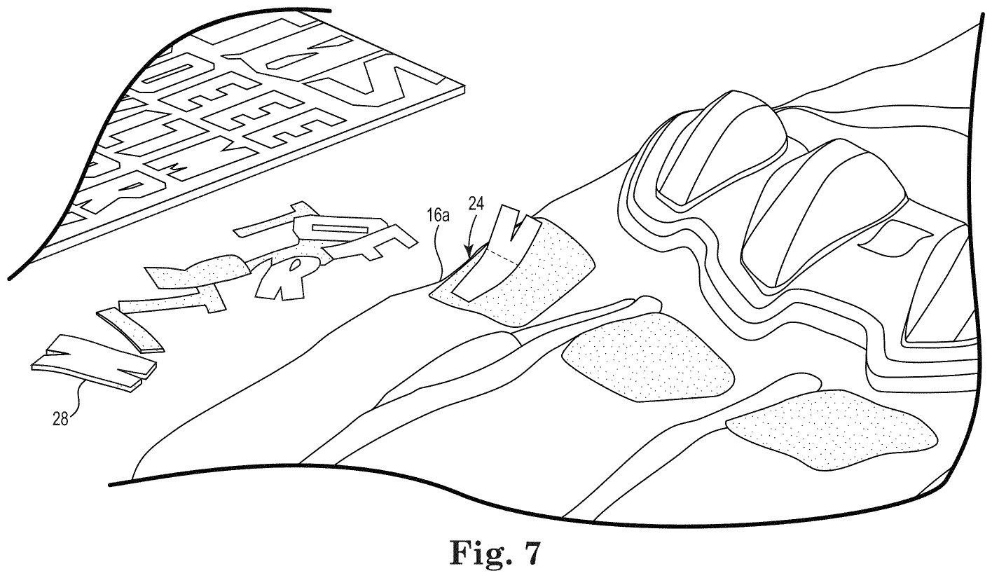

FIG. 6 shows a sheet 26 bearing an assortment of character patches 28. Character patches 28 can be letters, numbers, commonly used non-letter and non-number characters such as the pound sign (#), also known recently as a “hashtag”, all as illustrated in FIGS. 1 and 6. Other commonly-recognized, or readily recalled, characters can be included/used as desired. A set of the character patches, when separated from sheet 26, can be arranged to spell a word, for example on the glove, to present an impression, to make a statement, or to otherwise convey a message to a viewer. Such arrangement of character patches is generally used to convey a user-determined message to a certain audience, as opposed to conveying an artistic expression. But while the invention is not directed at artistic expression per se, the message can include an artistic expression component.

Sheet 26 has two primary layers, namely a backing layer 30 and a character patch layer 32, both illustrated in cross-section view in FIG. 6A. Backing layer 30 has a front side 34 facing toward the viewer, but not seen, in FIG. 6 and facing to the right in FIG. 6A. Backing layer 30 also has a rear side 36 facing away from the viewer, and not seen in FIG. 6, and facing toward the left in FIG. 6A.

For illustration only, and without limitation, the rear side 36 of backing layer 32 is defined by a woven substrate made of tough synthetic strands, thus a tough woven fabric; and the receptive loop fastener matrix is bonded to the woven substrate, thus defining the front side 34 of the backing layer.

For illustration only, and without limitation, character patch layer 32 is defined by a tough plastic substrate having a flat front surface, and a generally constant thickness, with the hook-type fasteners depending rearwardly from the tough plastic substrate toward backing layer 30 and the loop-type receptive fasteners. The front surface of layer 32, and thus the front surfaces, of patches 28, which will be exposed to view when the message has been mounted on the article of clothing or clothing accessory, can be decorated with any color, any pattern of color, or any external, internal, or subliminal message.

Both backing layer 30 and character patch layer 32 can be made of any material desired so long as the respective materials are tough enough to tolerate the physical stresses imposed as character patches are removed from the backing layer.

As illustrated in FIG. 6, each character is encompassed, surrounded, by material of the character patch layer which does not define a readily-recalled character, so that each character can be removed/pulled from the backing layer, from the character matrix, without applying a removal force to the edge of an adjacent character.

Character patch layer 32 has a front side 38 facing toward the viewer, and seen in FIG. 6, and facing toward the right in FIG. 6A. Character patch layer 32 also has a rear side 40, facing away from the viewer and not seen in FIG. 6, and facing to the left in FIG. 6A.

Front side 34 of backing layer 30 thus faces toward the rear side 40 of character patch layer 32. An array of hook-type fasteners 42 is disposed on the rear side of the character patch layer, and generally covers the entirety of the length and width of the character patch layer. An array of loop-type fasteners 44 is disposed on the front side of the backing layer and generally covers the entirety of the length and width of the backing layer. The arrays of hook and loop fasteners 42, 44 on the backing layer and the character patch layer thus generally face each other across the facing areas of the backing layer and the character patch layer. The arrays of hook and loop fasteners 42 and 44 are both represented by a single zigzag line 46 between the layers 30 and 32 in FIG. 6A. Accordingly, the character patch layer and the backing layer are mechanically attached/fastened to each other in the illustrations represented in FIGS. 6 and 6A by the mechanical interactions of the respective hook fasteners and loop fasteners on the character patch layer and the backing layer. No fastening features are typically disposed on the front side of the character patch layer or on the back side of the backing layer for the purpose of fastening the backing layer and the character patch layer to each other.

Character patches 28 are die-cut into and through substantially the full thickness of character patch layer 32 such that an edge of a respective character patch can be lifted and readily separated from the remainder of the character patch layer, and correspondingly the hooks on the respective character patch are separated from the respective loops on the backing layer which underlie the respective character patch. Once the edge of the character patch has been lifted, the entire character patch can be peeled away from the backing layer, away from sheet 26 so as to provide free-standing characters as shown in FIG. 7.

With the respective character patch thus separated from sheet 26, the separated character patch can be attached/affixed to a receptive patch at a destination substrate such as a loop patch on a glove as in FIGS. 1-3 and 5. This process, of removing a character patch from sheet 26 and attaching the removed character patch to one of receptive patches 24 on a glove finger or other substrate, is repeated as desired until the desired number of receptive patches on the glove have been populated with the desired set of character patches from sheet 26. Where a receptive patch 24 is sufficiently large, multiple character patches can be attached to a single receptive patch.

FIG. 7 shows a number of character patches 28 which have been removed from sheet 26, thus to represent a set of character patches selected by the user, to be attached, in a desired order/arrangement, to one or more receptive patches on a target substrate. FIG. 7 shows the lower portion of the letter “V” attached to glove finger segment 16a at the respective receptive patch 24 of loop-type fastener material, and wherein the upper portion of the letter “V” has not yet been attached. Given the condition illustrated in FIG. 7, the attachment of the letter “V” is further implemented by pressing the upper portion of the letter “V” against the underlying loop-type fastener material on receptive patch 24 whereby the hooks 42 on the rear side of the character patch engage the receptive loops on the outwardly-facing, e.g. front, side of the receptive patch on the glove finger.

A portion of the above discussion suggests removing a first character patch 28 from sheet 26 and attaching the first removed character patch to the target receptive patch before removing a second character patch from sheet 26. It is acceptable, and generally preferable, to first remove, from sheet 26, all character patches in a given user-determined set of patches which are to be used for a particular message, and to then begin arranging the character patches and/or attaching the character patches at the target receptive patch or patches.

FIGS. 1, 2, and 5 clearly illustrate character patches attached to receptive patches 24 of loop material on the glove finger. Though not illustrated, such character patches could also, or in the alternative, be attached to receptive patches 24 which may be attached to the back of the main body of the glove, or the front of the main body of the glove.

FIG. 8 shows the back of a backpack 48 having an elongate receptive patch 24 of loop fastener material, and a plurality of character patches 28 mounted/attached to the elongate receptive patch and conveying a certain message, including a hashtag message.

Receptive patches 24 of loop fasteners can be attached to the article of clothing by any known method including stitching and/or gluing the receptive patch to the article of clothing.

The sheet 26 of character patches can be as simple as providing a set of letters and/or numbers which includes a single one of each of the letters of the alphabet and/or a single one of each of a set of numbers such as 0-10, and/or a single one of a set of characters which are not numbers and not letters, but are known to the user. In the alternative, and as shown in FIG. 6, sheet 26 can include multiple character patches for ones of the letters or numbers which are used more frequently in the given language, or are used more frequently in the vernacular of by a target audience. For example, FIG. 6 includes multiple character patches representing each of the vowels and a few of the consonants. The character assortment can be different in different sheets 26, depending on the intended/expected audience of users, though it is up to each user to select, from a given sheet, or set of sheets, the character patches which meet his or her need for user-determined messages.

In light of the above, a supplier of sheets 26 can design, and make available, a first sheet product 26 which carries a first assortment of patches and a second sheet product 26 which carries a second different assortment of patches, each targeted at a different audience demographic or vernacular. The supplier might, for example and without limitation, have sheets 26 with different assortments of patches for each of (i) children, (ii) teenagers, (iii) young adults, (iv) older adults, (v) political conservatives, (vi) political liberals, (vii) preppers, and the like. The number of audiences to be targeted specifically with their own sheet design is a supplier decision. The differences between the respective sheets can be, for example and without limitation, the number of letter patches for each letter included on the sheet, the number of “number” patches for each number on the sheet, certain characters which are not numbers and not letters, and which appeal to the particular target audience, or certain graphics patches which appeal to the particular target audience.

Accordingly, a supplier can offer a number of different sheets 26, each having a different assortment of characters represented by the character patches on the respective sheets. Referring to the above listing of potential sheet designs, namely given the sheets which are offered by the sheet supplier, it is up to the user to first select, from among the offered sheets, which of the sheets he/she will use:

(i) children's sheet design,

(ii) teenagers' sheet design,

(iii) young adults' sheet design,

(iv) older adults' sheet design,

(v) political conservatives' sheet design

(vi) political liberals' sheet design,

(vii) preppers' sheet design, or

(viii) other sheet design.

However, it is the user who determines the message, or messages, to be displayed. Once the user determines what message or messages will be displayed, the user can then select from among the available sheet designs, which of the sheets will best satisfy his or her need for character patches. Based on the number of letters, numbers, symbols needed for the contemplated messaging, whether a single message or multiple messages, the user selects, from among the available sheet designs, that sheet design, or those sheet designs, which collectively offer the needed number of each of the characters needed for the intended messaging. Then, once the sheet or sheets 26 have been procured, the user selects the needed character patches from the respective sheets 26 to make the character sets needed for the messaging contemplated for a given article of clothing or clothing accessory. The user removes the selected set of character patches from the sheet or sheets, and applies the character patches to the respective receptive patches on the target article of clothing or clothing accessory. In some instances, multiple articles of clothing or clothing accessories will be targeted by a single user for receiving character patch messages in order to create desired messaging on multiple articles of clothing or clothing accessories. As desired, multiple messages can be attached to a single article of clothing or clothing accessory, using a single receptive patch or multiple receptive patches.

In the invention, the user can determine, can decide that a second message should be displayed. That second message can be displayed on the same article of clothing or clothing accessory, optionally on the same receptive patch, or a second different article of clothing or clothing accessory. The set of character patches for the second message can be selected from among the character patches remaining on the sheet or sheets 26 after a first set of character patches has been removed from the sheet 26 for creating the first message. In the alternative, and especially where the second message is to replace the first message on the same receptive patch on the same article of clothing or clothing accessory, some or all of the character patches which were used for creating the first message can be used to create the second set of character patches. For example, the first set of character patches can be removed from the article of clothing or clothing accessory, and arranged in a second different order in creating the second character set for the second message; or some or all of the character patches from the first set of character patches can be comingled with other character patches from a sheet 26, and the comingled character patches used in creating the second message

While the invention has been described with respect to hook-type fasteners being used on the character patches and loop-type fasteners being used on the receptive patches, the hook and loop arrangements can be reversed such that hooks are used on the receptive patch and loops are used on the character patch.

The invention has been described above with respect to character patches mounted on gloves and backpacks. The character patches disclosed herein can as well be used with any article of clothing or clothing accessory which bears a suitable receptive patch 24 which can mechanically attach to or otherwise capture a character patch having compatible hook or loop fasteners

While the invention has been described in conjunction with the specific embodiments outlined above, many alternatives, modifications and variations will be apparent to those skilled in the art. Accordingly, the embodiments of the invention, as set forth above, are intended to be illustrative, not limiting. Various changes may be made without departing from the spirit and scope of this invention.

What is claimed is:

1. In combination,
(a) an article of clothing or a clothing accessory, said article of clothing or clothing accessory comprising one or more receptive portions thereof adapted to receive and to hold one or more character patches which bear either hook-type fasteners or loop-type fasteners; and
(b) an assortment of at least first, second, and third character patches hearing at least first and second different readily-recalled characters, including at least one of letters, numbers, or other readily-recalled characters, said character patches having fronts and rears, each said character patch bearing a hook-type fastener area or a loop-type fastener area on the rear of the respective said character patch adapted to cooperate with the respective one or more receptive portions on said article of clothing or clothing accessory,
wherein said character patch assortment is adapted to a user of such character patches
(i) selecting a first set of at least first and second, but not all, of said character patches from said assortment of character patches, wherein a wide variety of user-determined messages can be created using said assortment of characters, and
(ii) arranging the first set of character patches in such an order as to create a user-determined message, and attaching the first set of character patches to said article of clothing or clothing accessory at the respective one or more receptive portions in the arranged order by attaching the respective hooks or loops on the character patches to the cooperating one or more receptive portions, and thereby fastening the created message to said article of clothing or clothing accessory.

2. A combination as in claim 1 wherein the first set of said character patches is not limited to artistic images only.

3. A combination as in claim 1 wherein the user determines the message to be displayed, and thereby determines which of the character patches, in the assortment of character patches, are selected for the first set of character patches.

4. A combination as in claim 1 wherein the particular characters in said assortment of character patches are selected by a supplier of such characters.

5. A combination as in claim 1 wherein said assortment of character patches is adapted to the user selecting, from said assortment of character patches, a second different set of character patches.

6. A combination as in claim 5 wherein said second set of character patches includes character patches from the first set of character patches, and wherein the first set of character patches is replaced with the second set of character patches on the respective article of clothing or clothing accessory.

7. A combination as in claim 1 wherein said readily recalled characters are commonly-known characters.

8. A combination as in claim 1 wherein said assortment of character patches is embodied in a character patch sheet, said character patch sheet comprising a backing layer and an overlying character patch layer,
said backing layer having a first length and a first width, a first front side and a first rear side, the front side bearing either hook-type fasteners or loop-type fasteners,
said overlying character patch layer having a second front side and a second rear side, and a thickness between the second front side and the second rear side, a second length overlying at least a portion of the first length, and a second width overlying at least a portion of the first width,
a plurality of said character patches being cut through the thickness of said overlying layer from the second front side to the second rear side so as to define, in said overlying character patch layer, an array of removable said character patches, a given said character patch having hook-type fasteners or loop-type fasteners, at the second rear side, attaching the respective said character patch to said backing layer and cooperating with the respective hook-type or loop-type fasteners on said backing layer.

9. A combination as in claim 8 wherein a given said character patch, in said character patch sheet, is at least partially encompassed by material of said overlying character patch layer which does not define a readily-recalled character.

10. A combination as in claim 8 wherein a user can pull a given said character patch from said backing layer, and can use the hook-type fasteners or loop-type fasteners on the back of the respective said character patch to attach the respective said character patch to said article of clothing or clothing accessory.

11. A combination as in claim 1 wherein the assortment of character patches includes an entire alphabet of individual patches as well as multiples of letters, as individual character patches, which letters are more frequently used in a given language.

12. A combination as in claim 1 wherein the assortment of character patches includes at least one creatively artistic or graphic image.

13. A combination as in claim 11, further comprising at least ten different individual number characters.

14. A combination as in claim 12, further comprising at least one commonly-used character which is neither a number nor a letter.

15. A combination as in claim 1, at least one of said character patches being adapted and configured to being attached, as an individual separate and distinct readily-recalled character, to a respective receptive portion of said article of clothing or clothing accessory.

16. A character patch sheet comprising a backing layer and an overlying character patch layer,
said backing layer having a first length and a first width, a first front side and a first rear side, the front side being adapted to receive and hold hook-type fasteners and/or loop-type fasteners,
said overlying character patch layer having a second front side and a second rear side, and a thickness between the second front side and the second rear side, a second length overlying at least a portion of the first length, and a second width overlying at least a portion of the first width,
an assortment of character patches, including at least one of number patches or letter patches, being cut through the thickness of said overlying character patch layer from the second front side to the second rear side, but not through the backing layer, so as to define, in said overlying character patch layer, an array of removable said character patches,
a given said character patch having hook-type fasteners or loop-type fasteners, at the second rear side, removably attaching the respective said character patch to said backing layer.

17. A character patch sheet as in claim 16 wherein a given said removable character patch, including the hook-type fasteners or loop-type fasteners can be pulled from said character patch sheet and attached to a receptive article adapted to receive and hold respective hook-type fasteners or loop-type fasteners.

18. A character patch sheet as in claim 16 which includes letter patches and number patches.

19. A character patch sheet as in claim 16 which includes letter patches, number patches, and symbols or graphics which are neither letters nor numbers.

20. A character patch sheet as in claim 16 which is devoid of patches which display only artistic content.

21. A character patch sheet as in claim 16 wherein the assortment of character patches includes an entire alphabet as well as multiples of letters which are used more frequently in a given language.

22. A character patch sheet as in claim 21, further comprising at least ten different number characters.

23. A character patch sheet as in claim 22, further comprising at least one commonly-used character which is neither a number nor a letter.

24. A method of creating a personalized article of clothing or a clothing accessory, comprising
(a) providing an article of clothing or a clothing accessory wherein the article of clothing or clothing accessory comprises one or more receptive portions thereof adapted to receive and to hold one or more character patches which bear either hook-type fasteners or loop-type fasteners;
(b) providing an assortment of at least first, second, and third character patches bearing at least first and second different readily-recalled characters, including at least one of letters, numbers, or other readily-recalled characters, the character patches having fronts and rears, each character patch bearing a hook-type fastener area or a loop-type fastener area on the rear of the respective character patch adapted to cooperate with the respective one or more portions on such article of clothing or clothing accessory;
(c) selecting a first set of at least first and second, but not all, of the character patches in the assortment of character patches; and
(d) arranging the first set of character patches in such an order as to create a user-determined message, and attaching the first set of character patches to the article of clothing or clothing accessory at the respective one or more receptive portions in the arranged order by attaching the respective hooks or loops on the character patches to the receptive portions on the article of clothing or clothing accessory.

25. A method as in claim 24, at least one of the character patches being adapted and configured to being attached, as an individual separate and distinct readily-recalled character, to a respective receptive portion of the article of clothing or clothing accessory.

26. A method as in claim 24 wherein a supplier of the assortment of character patches selects the characters to be included in the assortment of character patches.

27. A method as in claim 24 including the user selecting a second different set of character patches from the assortment of character patches, adapted to display a second different message, thereby creating first and second user-determined messages from the assortment of character patches.

28. A method as in claim 27, the second set of character patches including character patches from the first set of character patches, the user replacing the first set of character patches with the second set of character patches on the respective article of clothing or clothing accessory in such an order that the second different message is displayed.

29. A method as in claim 24 wherein the assortment of character patches is embodied in a character patch sheet, the character patch sheet comprising a backing layer and an overlying character patch layer,
the backing layer having a first length and a first width, a first front side and a first rear side, the front side being adapted to receive and hold hook-type fasteners and/or loop-type fasteners,
the overlying character patch layer having a second front side and a second rear side, and a thickness between the second front side and the second rear side, a second length overlying at least a portion of the first length, and a second width overlying at least a portion of the first width, the character patches being cut through the thickness of the overlying layer from the second front side to the second rear side so as to define, in the overlying character patch layer, the assortment of removable character patches in the character patch sheet, a given removable character patch having hook-type fasteners or loop-type fasteners, at the second rear side, attaching the respective character patch to the backing layer,
the method comprising the user selecting a message to be created using at least first and second ones, but not all, of the character patches from the assortment of character patches, and removing a plurality, but less than all, of the removable character patches from the backing layer according to the user-selected message, and using hook-type fasteners or loop-type fasteners on the backs of the respective removed character patches to attach the respective character patches to the one or more receptive portions of the article of clothing or clothing accessory.

30. A method as in claim 29, the user selecting a second different set of character patches from the assortment of character patches to be used to create a second different user-determined message, the user arranging the second set of character patches in an order so as to display the second different message, and attaching the second different set of character patches to a such article of clothing or clothing accessory in the arranged order.

31. A method as in claim 30 wherein the second set of character patches includes character patches from the first set of character patches.

32. A method of making a character patch sheet having a backing layer and an overlying layer of removably attached character patches, the method comprising:
(a) providing a backing layer having a first length and a first width, a first front side and a first rear side, the front side and being adapted to receive and hold hook-type fasteners and/or loop-type fasteners;
(b) attaching, to the backing layer, an overlying character patch layer having a second front side and a second rear side, and a thickness between the second front side and the second rear side, the overlying character patch layer having a second length and a second width defining an outer perimeter of the overlying character patch layer, the second length of the overlying layer overlying at least a portion of the first length of the backing layer, and the second width of the overlying layer overlying at least a portion of the first width of the backing layer;
(c) cutting an assortment of character patches through the thickness of the overlying layer from the second front side to the second rear side, but not through the backing layer, and inward of the perimeter of the overlying character patch layer, so as to define, within the outer perimeter of the overlying character patch layer, an array of removable character patches, a given character patch having hook-type fasteners or loop-type fasteners, at the second rear side, attaching the respective character patch to the backing layer.

33. A method as in claim 32 wherein a given removable character patch, including the hook-type fasteners or loop-type fasteners can be pulled from the character patch sheet and attached to a receptive article adapted to receive and hold respective hook-type fasteners or loop-type fasteners.

34. A method as in claim 32 including cutting the assortment of character patches to include letter patches and number patches.

35. A method as in claim 32, including cutting the assortment of character patches to include letter patches, number patches, and patches defining symbols which are neither letters or numbers.

36. A method as in claim 32 including cutting the assortment of character patches such that the assortment of character patches is devoid of being only patches which display only artistic content.
